(19) United States
(12) Patent Application Publication
(10) Pub. No.: US 2006/0282462 A1
(43) Pub. Date: Dec. 14, 2006

(54) Context-of-use-independent content systems

(75) Inventors: Dennis Van De Meulenhof, Helmond (NL); Pawel Musial, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/568,019

(22) PCT Filed: Aug. 10, 2004
(86) PCT No.: PCT/IB04/51444

§ 371 Date: Feb. 10, 2006

Related U.S. Application Data
(60) Provisional application No. 60/494,705, filed on Aug. 13, 2003.
(60) Provisional application No. 60/511,136, filed on Oct. 14, 2003.

(51) Int. Cl. G06F 17/00

(52) U.S. Cl. 707/104.1

(57) ABSTRACT

The system and method of the present invention provides a content system 100 and method having only relations between content 104 (e.g., relations between music, CD-cover and lyrics), and the content itself 103, and excludes any context-of-use information. Since any product or appliance 106 configured with an embodiment of the present invention (e.g. CD-player or Picture-viewer) is in the context-of-use, it is left to the product or appliance to distinguish content from content descriptions. Alternatively, an embodiment provides a post-processing system 105 that supplies a context.

The present invention relates to a method and system for defining context-of-use independent content systems.

In a content system the context-of-use determines the boundary between content and content description. Assume a content system stores compact disc (CD) related information like the music (i.e. audio-streams), CD-cover (i.e., pictures), lyrics (i.e., simple text), etc. In the context-of-use of a CD-player the music itself is considered to be the content whereas the CD-cover and the lyrics are considered to be the content description. On the other hand, in the context-of-use of a Picture-viewer, the picture of the CD-cover is considered to be the content whereas the music and the lyrics are considered to be content descriptions.

Therefore, if the context-of-use is unknown it is impossible for a content system to distinguish content from content descriptions because there is no context to support an interpretation. As a consequence, most prior art content systems use a pre-defined context-of-use in order to distinguish content from content descriptions and, as a result, these prior art systems are limited to coverage of a specific range of products. Moreover, if the predefined context-of-use changes over time these content systems have to be adapted to these changes as well.

A content system and method is needed that removes the boundary between content and content descriptions so that a content system's range of applicability can be defined when a context is applied. The system and method of the present invention provides a content system having only relations between content (e.g., relations between music, CD-cover and lyrics), and the content itself, and excludes any context-of-use information. Since any product or appliance configured with an embodiment of the present invention (e.g. CD-player or Picture-viewer) is in the context-of-use, it is left to the product or appliance to distinguish content from content descriptions.

The advantages of the system and method of the present invention include the use of the same content system in different contexts-of-use and a system that is more robust in a changing usage environment, i.e., a system that is less vulnerable to changes over time.

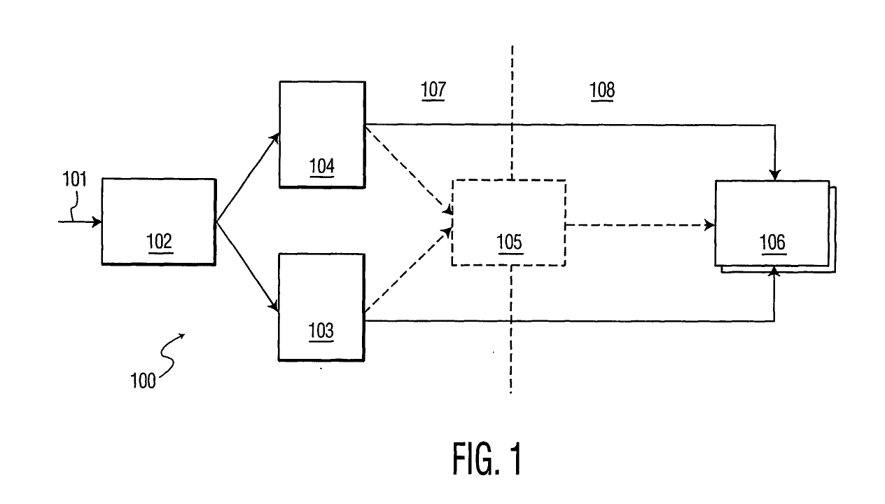

FIG. 1 illustrates a content system according to a preferred embodiment of the present invention;

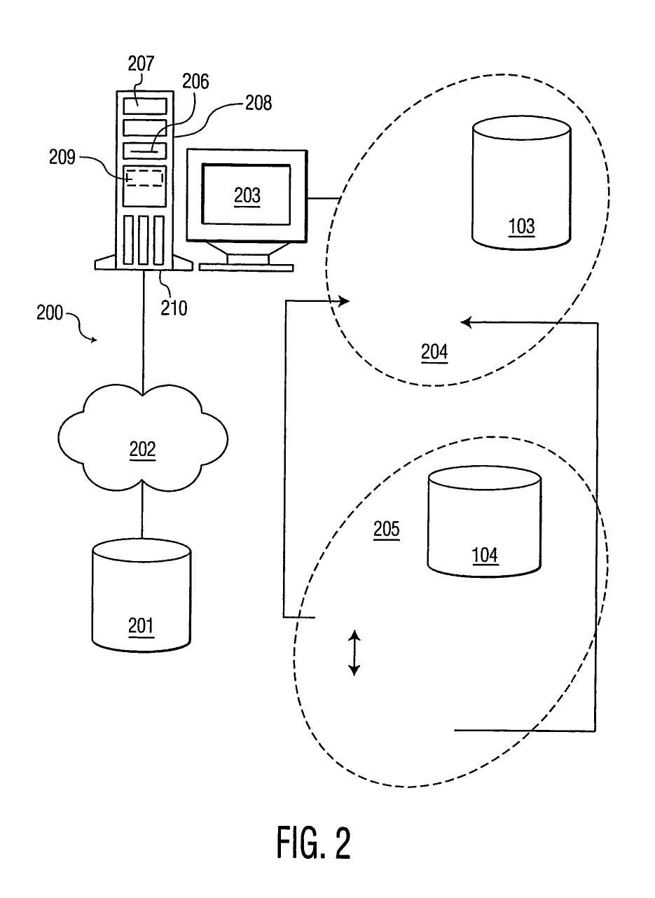

FIG. 2 illustrates a personal computer (PC) configured with the preferred embodiment of FIG. 1, obtaining content from a variety of sources and having a preferred database structure.

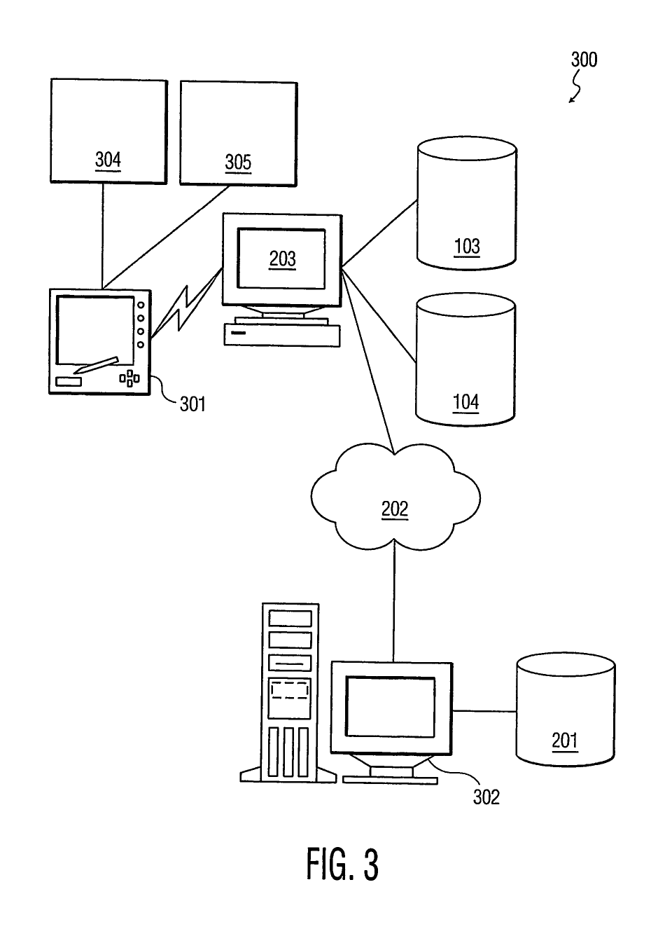

FIG. 3 illustrates a preferred embodiment of a personal digital assistant (PDA) configured with the preferred embodiment of FIG. 1 and having a subset of the content databases of the PC downloaded to the PDA storage.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 illustrates a preferred embodiment of a content system 100 that is independent of context-of-use, according to a preferred embodiment of the present invention. The retrieved, extracted or generated content 101 enters the system at a Pre-Processing module 102. The Pre-Processing module 102 validates the content and the Content Storage module 103, stores the content (optionally, a proxy approach can be used in which a stand-in for the content is stored and the content is stored elsewhere, e.g., a Universal Resource Locator (URL)). In case the content is new to the Content Storage module 103 the content will be added.

The Pre-Processing module 102 identifies relations between different types of content and offers these to the Content Relation Data Base (DB) module 104, which stores the content relations. Each content item can have any number of data file types associated with it, as illustrated in FIG. 2. By way of example only and not limitation, for a given content item, the Pre-Processing module 102 associates a unique identifier or Name with each of the different data types associated with the content item such that the unique identifier serves to relate the various data types. In FIG. 2 both Data1 and Data2 have the same name=Name. The Content Storage DB 103 is a set of files named Name.type, in a preferred embodiment. In an alternative preferred embodiment, the files of data are stored as a binary long object (blob) in a tuple having attributes of name, type, blob using a relational database. In still another preferred embodiment, the blob is replaced with a location of the data, e.g., a URL.

A product or appliance, i.e., a device, configured to execute a preferred embodiment of the present invention, queries the content system 100 either directly via the Content Relation DB module 104 and Content Storage module 103 or indirectly via a Post-Processing module 105. The Post-Processing module 105 combines the content relations with the actual content. The Post-Processing module 105 enables richer queries on the content itself (e.g. word search in text files), combining of content, allows different types of communication, etc.

In a preferred embodiment, the Post-Processing module 105 imposes a specific context-of-use in case the product or appliance is not able to do so. This forced context-of-use reflects, for example, a technical reason (e.g., performance or power consumption) or a marketing reason (e.g., a special offer for additional on-line services).

Consider a CD player and Picture Viewer. The Content Storage module 103 stores music, pictures and text files and the Content Relation DB module 104 stores all possible relations between these content types (i.e., music⇄pictures, text⇄music, pictures⇄text). Assume the Pre-Processing module 102 derives the lyrics for song A from an Internet CDDB-database. In a preferred embodiment, the Pre-Processing module 102 determines whether the lyrics are already stored (as text) in the Content Storage module 103. In case the lyrics are new, the Pre-Processing module 102 may offer a new text⇄music relation (e.g., lyrics⇄song A) to the Content Relation DB 104. In a preferred embodiment, if the lyrics are already stored then the Content Storage module 103 may update them, if necessary.

Assume a CD player interfaces directly to the content of a CD. Consumer A wants to hear song A from his new CD so he inserts the CD containing song A into the CD player. Upon insertion of the CD into the CD player the CD-player automatically queries the Content Relation DB module 104 in order to retrieve all possible content relations involving song A. Among others, it retrieves relations to a CD cover (i.e., picture) and to a lyric of song A (i.e., text). In a preferred embodiment, the CD player retrieves the content (picture and lyric) from the Content Storage module 103, interprets the retrieved content and presents it to the customer as content descriptions in the most suitable way.

Assume a Picture-viewer interfaces indirectly to the content system via a Post-Processing module 105. Consumer B is using the Picture Viewer to scan some pictures and is looking for the picture of the CD cover of the CD containing song A. Consumer B only remembers one sentence from the song A. Consumer B provides this one sentence to the Picture Viewer that in turn queries the content system 100 via the Post-Processing module 105. The Post-Processing module 105 queries the Content Storage module 103 for a lyric containing the provided sentence. The Content Storage module 103 finds the lyric containing the provided sentence is related to song A and queries the Content Relation DB module 104 to retrieve all relations to song A. It uses the lyrics*picture relation to retrieve the picture of a CD cover from the Content Storage module 104 and sends the retrieved picture of the CD cover to a Picture Viewer (not shown). In an alternative embodiment, the Post-Processing module 105 also provides a link to the music itself. The Picture Viewer (not shown) retrieves the content (music) from the Content Storage module 103, renders it and presents it to the customer as content descriptions in the most suitable way (e.g., plays only a few seconds of the most characteristic part).

Other devices can incorporate a preferred embodiment of the content system of the present invention. As illustrated in FIG. 2, a networked personal computer 210 can have a DVD player, a CD player 206, a video player 203, an audio cassette player 201 and the content can be downloaded and stored in a file or on a removable media, such as a CD or DVD. The Content Storage DB 103 and the Content Relation DB 104 can be downloaded to the PC 210 and software modules 208 of the Content System can be executed in the same way other programs are downloaded and executed, e.g., RealPlayer executes as a program on a PC and plays downloaded and CD-resident files.

FIG. 3 illustrates a personal digital assistant (PDA) 301 having a preferred embodiment of the present invention as a resident application in both the PC 203 and the PDA 301 with downloaded content from the PC 203 resident on the PDA 301. A wireless connection to the Internet 202 enables downloading of content directly by a PDA 301 in a preferred embodiment of the present invention.

Other appliances also can be configured to host an embodiment of the present invention, such as a vehicle navigation system with either CD as the storage medium or downloaded files, e.g., from a Wireless Internet connection stored on local non-volatile memory resident in the vehicle. Kiosks in malls and other locations (government buildings) can employ removable media for content or downloaded content files from the Internet or a dedicated networked data source, the Kiosks being used as information desks.

A preferred embodiment comprises a processor or set of dedicated chips that executes the various modules illustrated in FIG. 1 and non-volatile storage for a Content Relation DB 104 and a Content Storage DB 103. For simpler devices, content can be preformatted and stored on memory devices thus eliminating the Pre-Processing module 102.

While the preferred embodiments of the present invention have been illustrated and described, it will be understood by those skilled in the art that various changes and modifications may be made, and equivalents may be substituted for elements thereof without departing from the true scope of the present invention. For example, other products or appliances that can host an embodiment of the present invention include any that can employ content to direct their operation or diagnose their malfunction and direct corrective action using pre-stored, pre-formatted material. Examples include intelligent appliances, copier help screens (hardware component) for diagnosing problems and suggesting solutions, and Help Files on a computing device (software module) with pop ups that optionally include audio and video clips.

In addition, many modifications may be made to adapt to a particular situation and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

What is claimed is:

1. A method for a context-of-use-independent content system, comprising the steps of:
providing content data 101 for an item, said content data having a type;
specifying selection criteria 105 106; and
outputting 103 104 105 said content data and type that satisfies said selection criteria.

2. The method of claim 1, wherein:
said specifying step further comprises specifying a context 105 106; and
said outputting 105 step further comprises outputting said content data as content when the type of the content data matches the context and as content description otherwise.

3. The method of claim 2, wherein the specifying step further comprises the step of specifying a context 105 106 selected from the group consisting of audio cassette player, CD player, DVD player, picture viewer, software module, hardware component, electronic device, and portable electronic device.

4. The method of claim 1, wherein the providing step further comprises the step of downloading 102 203 the content data and type for an item over a network 202 from a content source 201.

5. The method of claim 1, wherein the providing step further comprises the step of providing a proxy for the content data.

6. The method of claim 1, further comprising the step of providing a context-of-use independent subsystem 107 to perform said providing step and said outputting step.

7. The method of claim 6, further comprising the step of configuring the context-of-use independent subsystem 107 to include:
a content storage database 103 to store said content data and type for an item and output therefrom content data and type that satisfy the specified selection criteria;
a content relation database 104 to store relationships between the stored content data for an item and output therefrom relationships between stored content data that satisfy the specified selection criteria; and
a pre-processing module 102 that performs the steps of
storing the content data in the content storage database, and
creating and storing relationships between the content data for an item in the content relation database.

8. The method of claim 7, further comprising the step of configuring a context-of-use dependent system 108 to perform said specifying step.

9. The method of claim 8, wherein said configuring step further comprises the step of configuring the context-of-use-dependent subsystem 108 to include a post-processing subsystem 105 that performs the outputting step to output data and type and relationships respectively retrieved from the content storage database 103 and the content relation database 104 that satisfy the specified selection criteria.

10. The method of claim 1, wherein said specifying step further comprises configuring a context-of-use dependent subsystem 108 to perform said specifying step.

11. The method of claim 10, wherein said configuring step further comprises the step of configuring the context-of-use-dependent subsystem to include a post-processing subsystem 105 that performs the outputting step to output data and type and relationships respectively retrieved from the content storage database 103 and the content relation database 104 that satisfy the specified selection criteria.

12. An apparatus for a context-of-use-independent content system, comprising:
a content storage database 103 to store said content data and type for an item and output content data and type that satisfy a specified selection criteria;
a content relation database 104 to store relationships between the stored content data for an item and output relationships between stored content data that satisfy the specified selection criteria; and
a pre-processing module 102 arranged to
receive content data 101 having a type,
store content data and type in the content storage database 103, and
create and store in the content relation database 104, relationships between content data for an item stored in the content storage database 103.

13. The apparatus of claim 12, further comprising a post-processing module 105 that provides the specified selection.

14. The apparatus of claim 13, wherein the post-processing system 105 receives the output content data and type and relationships and then outputs content data as content when the type of the content data matches a specified context and as content description otherwise.

15. The apparatus of claim 14, wherein the specified context is selected from the group consisting of audio cassette player, CD player, DVD player, picture viewer, software module, hardware component, electronic device, and portable electronic device.

16. The apparatus of claim 13, wherein the received content data is downloaded 102 203 over a network 202 from a content source 201.

17. The apparatus of claim 13, wherein said received content data is a proxy for said content data.
